(19) United States
(12) Patent Application Publication
(10) Pub. No.: US 2019/0197549 A1
(43) Pub. Date: Jun. 27, 2019

(54) ROBUST FEATURES GENERATION ARCHITECTURE FOR FRAUD MODELING

(71) Applicant: PAYPAL, INC., San Jose, CA (US)

(72) Inventor: Nitin Satyanarayan Sharma, San Jose, CA (US)

(21) Appl. No.: 15/851,616

(22) Filed: Dec. 21, 2017

(51) Int. Cl. G06Q 20/40; G06N 3/04

(52) U.S. Cl. CPC G06Q 20/4016; G06N 3/04

(57) ABSTRACT

Methods and systems for generating robust computer models for detecting fraudulent electronic transactions are presented herein. A set of dominative features is selected from candidate features using multiple feature selection algorithms, where each dominative feature in the set of dominative features is dominative over every remaining candidate feature. The multiple feature selection algorithms may include at least one univariate feature selection algorithm and at least one multivariate feature selection algorithm. The set of dominative features may be reduced to a number of representations, where each representation represents an aspect of the set of dominative features. The representations may then be used to generate the robust computer model.

### BACKGROUND

The present specification generally relates to fraud modeling, and more specifically to, generating robust computer models for detecting fraudulent electronic transactions.

### RELATED ART

Tactics in performing fraudulent transactions electronically are ever-evolving and becoming more sophisticated. Entities that provide services electronically need to keep pace with the fraudulent users in providing security measures, such as accurately detecting fraud transactions in real-time. In this regard, computer models are often utilized to assist in making a real-time determination of whether a transaction is a fraudulent transaction or not. The computer models usually ingest data related to the transaction, perform analyses on the ingested data, and provide an outcome. A decision of whether to authorize or deny the transaction may then be made based on the outcome.

As mentioned above, fraudulent transaction tactics are dynamic and may change from time to time. For example, old tactics that were not used recently may reemerge as a new trend, new tactics may be introduced, and tactics may reemerge periodically as a seasonal trend. To add to the complication, the user population of the services may also change from time to time. For example, the services may be introduced to a new geographical region, which exhibits different fraudulent behavior than the existing user population. As a result, computer models that focus on maximizing performance based on recent fraudulent transaction data may underperform (e.g., fail to identify fraudulent transactions) in the future. Entities may have to generate new computer models from time to time to target new tactics and new fraud trends. However, constantly generating new computer models for detecting fraudulent transactions is costly, and it is difficult to predict the appropriate time to generate and release a new computer model. Thus, there is a need for systems and methods that generate robust computer models for detecting fraudulent transactions.

### BRIEF DESCRIPTION OF THE FIGURES

FIG. 1 is a block diagram illustrating an electronic transaction system according to an embodiment of the present disclosure;

FIG. 2 is a block diagram illustrating a risk analysis module according to an embodiment of the present disclosure;

FIG. 3 is a block diagram illustrating a model generation module according to an embodiment of the present disclosure;

FIG. 4 is a flowchart showing a process of generating a risk analysis model according to an embodiment of the present disclosure;

FIG. 5 illustrates selecting a set of dominative features according to an embodiment of the present disclosure;

FIG. 6 illustrates an exemplary artificial neural network according to an embodiment of the present disclosure;

FIG. 7 is a flowchart showing a process of generating a targeted risk analysis model from a generic risk analysis model according to an embodiment of the present disclosure;

FIG. 8 illustrates transferring knowledge from a generic risk analysis model to a targeted risk analysis model according to an embodiment of the present disclosure; and

FIG. 9 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for generating robust computer models for detecting potential or possible fraudulent electronic transactions. A computer model generated for detecting fraudulent electronic transactions may use a set of data related to an electronic transaction to predict whether the electronic transaction is a possible, potential, or likely fraudulent transaction. The set of data may include a transaction type, a transaction amount, a user account associated with the transaction, a browser type of a browser used to initiate the transaction, a device type of a device used to initiate the transaction, an Internet Protocol (IP) address of the device used to initiate the transaction, and other information related to the transaction. Some of these data types (also referred to as “features” herein) may be more relevant (or more determinative) for detecting fraudulent transactions than others. As such, in one aspect of the disclosure, a set of dominative features may be determined for the computer model for detecting fraudulent transactions. In some embodiments, multiple feature selection algorithms may be used to determine the set of dominative features. The multiple feature selection algorithms may include at least one univariate feature selection algorithm and at least one multivariate feature selection algorithm.

In some embodiments, the feature selection algorithms may be used to analyze a number of candidate features related to an electronic transaction. Each feature selection algorithm may rank (or score) the candidate features according to a set of criteria associated with the feature selection algorithm. As such, the candidate features may be ranked (or scored) differently according to the different feature selection algorithms. The set of dominative features may then be determined by analyzing the different rankings (or scores) of the potential features. The set of dominative features may include only a portion, but not all, of the candidate features that are related to or associated with an electronic transaction.

In some embodiments, the set of dominative features may be dominative over the remaining candidate features across the multiple feature selection algorithms. In other words, each dominative feature in the set may be ranked above every candidate feature not within the set. It has been contemplated that the set of dominative features that are selected in this manner is robust because the dominative features are dominative over other features not just based on one set of criteria, but based on multiple sets of criteria corresponding to the multiple different feature selection algorithms. The set of dominative features may then be compressed (or reduced) into a number of representations, wherein the number of representations is fewer than the set of dominative features. An artificial neural network may be used to generate the number of representations such that the representations accurately represent the set of dominative features. In some embodiments, each representation represents a different aspect of the set of dominative features.

The artificial neural network may be configured to take input variables corresponding to the set of dominative features as input data. As such, the artificial neural network may include a number of nodes in an input layer of the network, where each node in the input layer corresponds to a distinct dominative feature.

In some embodiments, the artificial neural network may include a number of nodes in a hidden layer. The number of nodes in the hidden layer may be less than the number of nodes in the input layer. For example, if 700 of dominative features have been determined for the computer model, the artificial neural network may include only 20 nodes in the hidden layer. Each node in the hidden layer may include a representation of all of the dominative features. For example, the representation may be expressed as a mathematical computation that computes a value based on the input values corresponding to the set of dominative features.

Thus, the preliminary neural network is configured to compress the input variables into fewer numbers of representations. Using the example given above, when the set of dominative features include 700 features, the neural network may compress the 700 input variables corresponding to the 700 features into 20 representations. Each of the 20 representations may include a different mathematical computation that computes a value based on all of the 700 input variables. As such, each representation may represent a different aspect of the dominative features.

Furthermore, instead of generating a binary output of whether a fraudulent transaction is detected (having only one node in the output layer), the artificial neural network may be trained to reproduce the input variables based on the representations of the nodes in the hidden layer. As such, the preliminary neural network may include the same number of nodes in the output layer as the input layer. Each node in the output layer may correspond to a node in the input layer (a dominative feature). Training data is provided to the artificial neural network to train the artificial neural network to reproduce the input variables as output, based on the compressed representations in the hidden layers. During the training, the representations in the hidden layer may be adjusted and/or refined to improve the performance and accuracy of reproducing the original input variables.

After training, the nodes in the hidden layers may then be used as nodes in the input layer of a final risk analysis computer model for detecting fraudulent electronic transactions. Since the representations in the hidden layer from the artificial neural network enable an accurate reproduction of the input variables, these representations may accurately and efficiently represent the large number of input variables and features in the final risk analysis model. The final computer model may then be trained to predict/determine whether an electronic transaction is fraudulent using another set of training data.

As discussed above, fraud trends may be seasonal, or may change over time due to new tactics or new user population being introduced to the system. While the techniques disclosed above may produce a robust computer model, the performance of the risk analysis model may depend on the type of training data being used to train the risk analysis model. For example, when the training data does not include data captured in recent time periods, the risk analysis model may not be adequate to detect seasonal or the latest fraud tactics. While a new risk analysis model may be generated using the latest data, constantly generating new models can be costly. Furthermore, while the new risk analysis model may be adequate in detecting the latest fraud tactics, its performance may suffer when an older fraud tactic reemerges. Thus, in another aspect of the disclosure, a knowledge transfer technique is used to generate a targeted risk analysis model from a generic risk analysis model.

According to various embodiments of the disclosure, a first (generic) risk analysis model may be generated to produce an outcome (e.g., a determination of whether a transaction is a fraudulent transaction) based on a set of input data related to a first set of features. For example, the first risk analysis model may be generated using the techniques described above. The first computer model may then be enhanced to produce a second (targeted) risk analysis model, where the knowledge from the first computer model is retained and added to the second computer model.

Different types of knowledge transfers have been contemplated. For example, the transfer of knowledge may be temporal-based or domain-based. When a temporal-based knowledge transfer is requested, the first computer model is trained using a first set of training data that corresponds to a first time period. Based on the request, a second set of training data that corresponds to a second time period may then be obtained. The second time period may be subsequent to the first period of time. The first computer model is adjusted to produce the second computer model. On the other hand, when a domain-based knowledge transfer is requested, the first computer model is trained using a third set of training data that is related to a first risk domain. Based on the request, a fourth set of training data related to a second risk domain may then be obtained. The first computer model is adjusted to produce the second computer model by retraining the first computer model using the fourth set of training data.

In some embodiments, the first domain is a generic fraud domain and the second domain is a type of fraud sub-domain of the generic fraud domain. For example, the first domain is a generic fraud domain, and the first set of training data corresponds to all types of frauds. The second domain may be a specific type of fraud, such as an account take-over sub-domain or a card fraud sub-domain, and the second set of training data corresponds to training data related to a specific type of fraud.

With the transfer of knowledge, the targeted (second) risk analysis model not only is capable of detecting fraud tactics that only arise in recent time or a specific type of fraud, the targeted risk analysis model is also capable of detecting older fraud tactics and/or other types of fraud generally based on the knowledge that is transferred from the generic (first) risk analysis model. This is especially useful when older fraud tactics may reemerge or fraud transactions may be incorrectly classified before being processed by the targeted computer model.

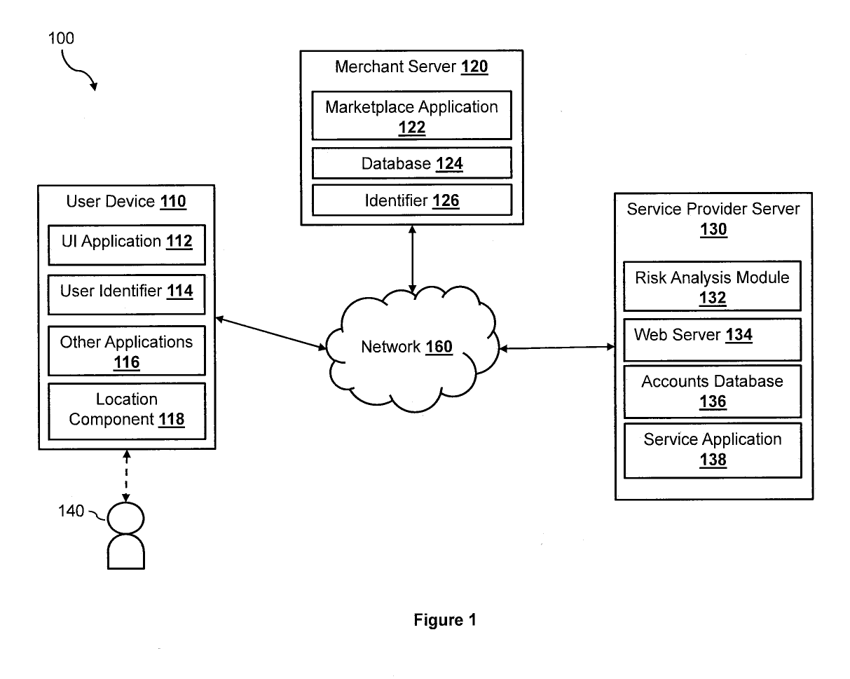

FIG. 1 illustrates an electronic transaction system 100 according to one embodiment of the disclosure. The electronic transaction system 100 includes a service provider server 130, a merchant server 120, and a user device 110 that may be communicatively coupled with each other via a network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110, in one embodiment, may be utilized by a user 140 to interact with the merchant server 120 and/or the service provider server 130 over the network 160. For example, the user 140 may use the user device 110 to log in to a user account to conduct account services or conduct financial transactions (e.g., account transfers or payments) with the service provider server 130. Similarly, a merchant associated with the merchant server 120 may use the merchant server 120 to log in to a merchant account to conduct account services or conduct financial transactions (e.g., payment transactions) with the service provider server 130. The user device 110, in various embodiments, may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one embodiment, includes a user interface application 112 (e.g., a web browser), which may be utilized by the user to conduct transactions (e.g., shopping, purchasing, bidding, etc.) with the service provider server 130 over the network 160. In one aspect, purchase expenses may be directly and/or automatically debited from an account related to the user via the user interface application 112.

In one implementation, the user interface application 112 includes a software program, such as a graphical user interface (GUI), executable by a processor that is configured to interface and communicate with the service provider server 130 via the network 160. In another implementation, the user interface application 112 includes a browser module that provides a network interface to browse information available over the network 160. For example, the user interface application 112 may be implemented, in part, as a web browser to view information available over the network 160.

The user device 110, in various embodiments, may include other applications 116 as may be desired in one or more embodiments of the present disclosure to provide additional features available to the user 140. In one example, such other applications 116 may include security applications for implementing client-side security features, programmatic client applications for interfacing with appropriate application programming interfaces (APIs) over the network 160, and/or various other types of generally known programs and/or software applications. In still other examples, the other applications 116 may interface with the user interface application 112 for improved efficiency and convenience.

The user device 110, in one embodiment, may include at least one user identifier 114, which may be implemented, for example, as operating system registry entries, cookies associated with the user interface application 112, identifiers associated with hardware of the user device 110 (e.g., a media control access (MAC) address), or various other appropriate identifiers. The user identifier 118 may include one or more attributes related to the user 140 of the user device 110, such as personal information related to the user (e.g., one or more user names, passwords, photograph images, biometric IDs, addresses, phone numbers, social security number, etc.) and banking information and/or funding sources (e.g., one or more banking institutions, credit card issuers, user account numbers, security data and information, etc.). In various implementations, the user identifier 114 may be passed with a user login request to the service provider server 130 via the network 160, and the user identifier 114 may be used by the service provider server 130 to associate the user with a particular user account maintained by the service provider server 130.

In various implementations, the user 140 is able to input data and information into an input component (e.g., a keyboard) of the user device 110 to provide user information with a transaction request, such as a login request, fund transfer request, a request for adding an additional funding source (e.g., a new credit card), or other types of request. The user information may include user identification information.

The user device 110, in various embodiments, include a location component 118 configured to determine, track, monitor, and/or provide an instant geographical location of the user device 110. In one implementation, the geographical location may include GPS coordinates, zip-code information, area-code information, street address information, and/or various other generally known types of location information. In one example, the location information may be directly entered into the user device 110 by the user via a user input component, such as a keyboard, touch display, and/or voice recognition microphone. In another example, the location information may be automatically obtained and/or provided by the user device 110 via an internal or external monitoring component that utilizes a global positioning system (GPS), which uses satellite-based positioning, and/or assisted GPS (A-GPS), which uses cell tower information to improve reliability and accuracy of GPS-based positioning. In other embodiments, the location information may be automatically obtained without the use of GPS. In some instances, cell signals or wireless signals are used. For example, location information may be obtained by checking in using the user device 110 via a check-in device at a location, such as a beacon. This helps to save battery life and to allow for better indoor location where GPS typically does not work.

Even though only one user device 110 is shown in FIG. 1, it has been contemplated that one or more user devices (each similar to user device 110) may be communicatively coupled with the service provider server 130 via the network 160 within the system 100.

The merchant server 120, in various embodiments, may be maintained by a business entity (or in some cases, by a partner of a business entity that processes transactions on behalf of business entity). Examples of businesses entities include merchant sites, resource information sites, utility sites, real estate management sites, social networking sites, etc., which offer various items for purchase and process payments for the purchases. The merchant server 120 may include a merchant database 124 for identifying available items, which may be made available to the user device 110 for viewing and purchase by the user.

The merchant server 122, in one embodiment, may include a marketplace application 122, which may be configured to provide information over the network 160 to the user interface application 112 of the user device 110. For example, the user 140 of the user device 110 may interact with the marketplace application 122 through the user interface application 112 over the network 160 to search and view various items available for purchase in the merchant database 124.

The merchant server 120, in one embodiment, may include at least one merchant identifier 126, which may be included as part of the one or more items made available for purchase so that, e.g., particular items are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

A merchant may also use the merchant server 120 to communicate with the service provider server 130 over the network 160. For example, the merchant may use the merchant server 120 to communicate with the service provider server 130 in the course of various services offered by the service provider to a merchant, such as payment intermediary between customers of the merchant and the merchant itself. For example, the merchant server 120 may use an application programming interface (API) that allows it to offer sale of goods in which customers are allowed to make payment through the service provider server 130, while the user 140 may have an account with the service provider server 130 that allows the user 140 to use the service provider server 130 for making payments to merchants that allow use of authentication, authorization, and payment services of the service provider as a payment intermediary. The merchant may also have an account with the service provider server 130. Even though only one merchant server 120 is shown in FIG. 1, it has been contemplated that one or more merchant servers (each similar to merchant server 120) may be communicatively coupled with the service provider server 130 and the user device 110 via the network 160 in the system 100.

The service provider server 130, in one embodiment, may be maintained by a transaction processing entity or an online service provider, which may provide processing for financial transactions and/or information transactions between the user 140 of user device 110 and one or more merchants. As such, the service provider server 130 may include a service application 138, which may be adapted to interact with the user device 110 and/or the merchant server 120 over the network 160 to facilitate the searching, selection, purchase, payment of items, and/or other services offered by the service provider server 130. In one example, the service provider server 130 may be provided by PayPal®, Inc., eBay® of San Jose, Calif., USA, and/or one or more financial institutions or a respective intermediary that may provide multiple point of sale devices at various locations to facilitate transaction routings between merchants and, for example, financial institutions.

In some embodiments, the service application 138 may include a payment processing application (not shown) for processing purchases and/or payments for financial transactions between a user and a merchant. In one implementation, the payment processing application assists with resolving financial transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 may also include a web server 134 that is configured to serve web content to users in response to HTTP requests. As such, the web server 134 may include pre-generated web content ready to be served to users. For example, the web server 134 may store a log-in page, and is configured to serve the log-in page to users for logging into user accounts of the users to access various service provided by the service provider server 130. The web server 134 may also include other webpages associated with the different services offered by the service provider server 130. As a result, a user may access a user account associated with the user and access various services offered by the service provider server 130, by generating HTTP requests directed at the service provider server 130.

In various embodiments, the service provider server includes a risk analysis module 132 that is configured to determine whether to authorize or deny an incoming request from the user device 110 or from the merchant server 120. The request may be a log-in request, a fund transfer request, a request for adding an additional funding source, or other types of requests associated with the variety of services offered by the service provider server 130. As such, when a new request is received at the service provider server 130 (e.g., by the web server 134), the risk analysis module 132 may analyze the request and determine whether to authorize of deny the request. The risk analysis module 132 may transmit an indication of whether to authorize or deny the request to the web server 134 and/or the service application 138 such that the web server 134 and/or the service application 138 may process the request based on the indication.

The service provider server 130, in one embodiment, may be configured to maintain one or more user accounts and merchant accounts in an account database 136, each of which may include account information associated with one or more individual users (e.g., the user 140 associated with user device 110) and merchants. For example, account information may include private financial information of users and merchants, such as one or more account numbers, passwords, credit card information, banking information, digital wallets used, or other types of financial information, transaction history, Internet Protocol (IP) addresses, device information associated with the user account, which may be used by the risk analysis module 132 to determine whether to authorize or deny a request associated with the user account. In certain embodiments, account information also includes user purchase profile information such as account funding options and payment options associated with the user, payment information, receipts, and other information collected in response to completed funding and/or payment transactions.

User purchase profile information may be compiled or determined in any suitable way. In some instances, some information is solicited when a user first registers with a service provider. The information might include demographic information, a survey of purchase interests, and/or a survey of past purchases. In other instances, information may be obtained from other databases. In certain instances, information about the user and products purchased are collected as the user shops and purchases various items.

In one implementation, a user may have identity attributes stored with the service provider server 130, and the user may have credentials to authenticate or verify identity with the service provider server 130. User attributes may include personal information, banking information and/or funding sources. In various aspects, the user attributes may be passed to the service provider server 130 as part of a login, search, selection, purchase, and/or payment request, and the user attributes may be utilized by the service provider server 130 to associate the user with one or more particular user accounts maintained by the service provider server 130.

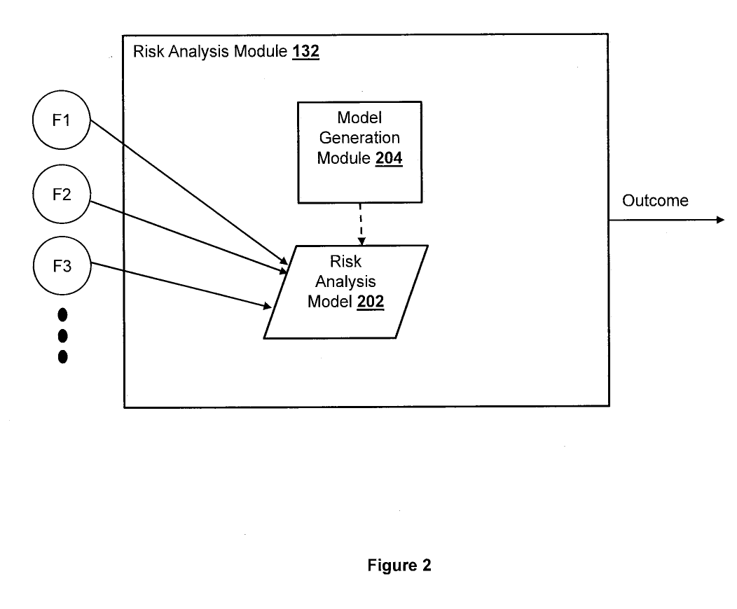

FIG. 2 illustrates a block diagram of the risk analysis module 132 according to an embodiment of the disclosure. The risk analysis module 132 includes a model generation module 204 for generating a risk analysis model 202. The risk analysis model 202 is a computer model that receives data related to an electronic transaction request, such as a log-in request, a fund transfer (e.g., payment) request, or a request for adding an additional funding source to a user account, etc., analyzes the data, and produces an outcome for the request based on a determination of whether the request may be a fraudulent request. As discussed above, malicious users often use different fraud tactics in an attempt to gain access to a user account through the service provider server 130 to perform unauthorized transactions using the user account that are unknown or not authorized by the legitimate owner of the user account. For example, malicious users may use a phishing technique or a man-in-the-middle attack to obtain user credentials associated with a user account. Typically, a transaction request initiated by a malicious user (an unauthorized user) may offer clues that the request is not generated by an authorized user. For example, the transaction request initiated by the unauthorized user usually has characteristics that are different from the characteristics of past transaction requests generated by the legitimate users. The characteristics may include a location from which the request is generated (e.g., indicated by an IP address of a device that initiated the request), a device type used to initiate the request, a browser type used to initiate the request, etc. Furthermore, due to the fact that the malicious user may have obtained most, but not all, of the user credentials, the malicious user may fail a login attempt several times before “guessing” the correct user credentials. As such, the number of times that a failed login attempt has occurred in a period of time may indicate that the request is a fraudulent request. As such, the risk analysis model 202 may obtain data related to an electronic transaction request, which may include an IP address of a source device, a device type of the source device, a number of successful transactions conducted for the user account within a period of time, a number of failed transactions using the user account attempted within a period of time, a current time, a browser type of a browser used to generate the request, an amount associated with the request, a transaction type of the request, and other information related to the request. In some embodiments, the risk analysis model 202 is trained or configured to predict whether a request is a possible fraudulent request based on the received data. As such, the outcome produced by the risk analysis model 202 may be a binary outcome that is either a possible fraudulent request or a legitimate request. In some embodiments, the outcome may be a score indicating a degree of likelihood that the transaction request is a fraudulent request. The risk analysis module 132 may then provide an indication of the outcome generated by the risk analysis model 202 to other modules or servers within the service provider server 130, such as the web server 134 and/or the service application 138, such that the other modules may process the transaction request accordingly.

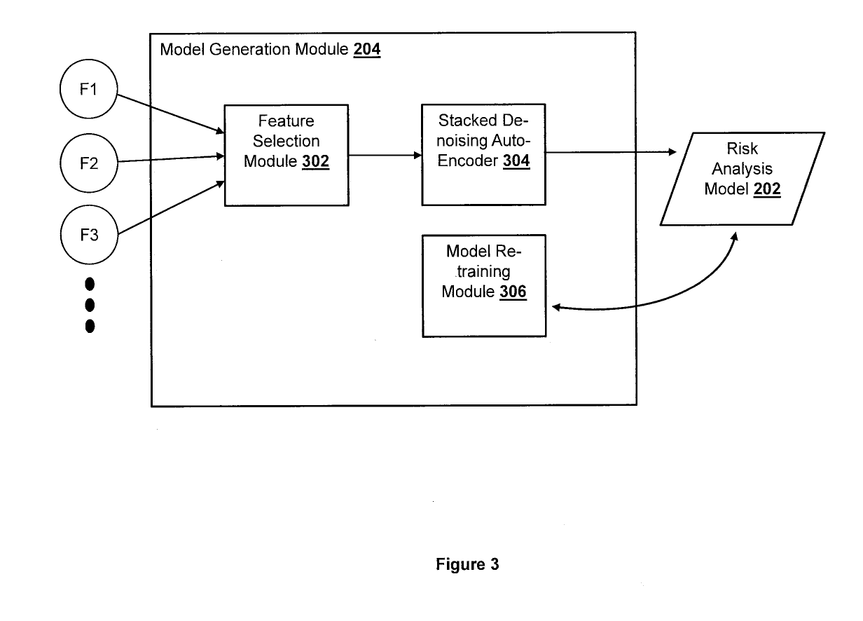

FIG. 3 illustrates a block diagram of the model generation module 204 according to an embodiment of the disclosure. The model generation module 204 includes a feature selection module 302, a stacked de-noising auto-encoder 304, and a model re-training module 306. In some embodiments, the feature selection module 302 obtains a set of features that are related to an electronic transaction and determines a subset of dominative features from the set. The stacked de-noising auto-encoder 304 further condenses the subset of dominative features into a set of representations that may be used as input variables for the risk analysis model 202.

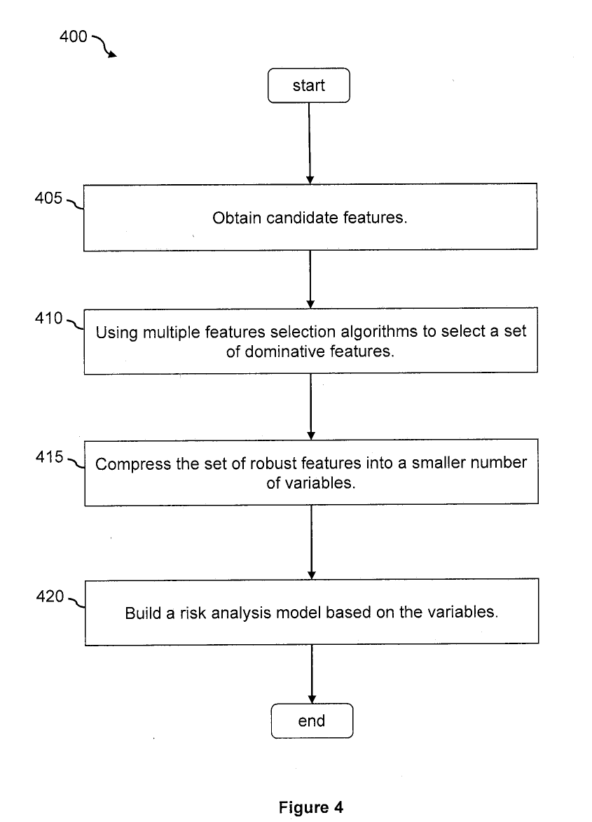

FIG. 4 illustrates a process 400 for generating a risk analysis model according to an embodiment of the disclosure. In some embodiments, the process 400 may be performed by the model generation module 204. The process 400 begins by obtaining (at step 405) candidate features related to detecting fraudulent transactions. As discussed above, a feature is a type of data that may be used by the risk analysis model to determine whether a transaction request is a possible fraudulent request or not. In some embodiments, the candidate features may be obtained based on empirical data in analyzing historic fraudulent transactions. In such an analysis, many data types related to a request may be inspected to determine if the data is relevant in detecting a possible fraudulent transaction request. For example, one may determine that the IP address of a source device that initiates the request is relevant in detecting fraudulent transaction request because an IP address corresponding to a geographical region that is far away from the IP address normally used by the user account may be indicative that the user account is being accessed by an unauthorized user. In another example, one may determine that when the user account has been unsuccessfully accessed more than a number of times prior to the request may be indicative that an unauthorized user is attempting to access the user account. While only two example features are described here, features that are relevant to detecting fraudulent requests may be up to hundreds or thousands in number.

While all of the candidate features may be relevant to detecting fraudulent transaction requests, they may not have equal relevancy. In other words, some candidate features may be more relevant (or more indicative) in detecting fraudulent transaction requests than others. Using weak candidate features in the risk analysis model may substantially reduce the performance of the risk analysis model as they may cause false negative determinations and/or false positive determinations. Given that the potentially large number of candidate features and that some features may not be sufficiently indicative of fraudulent requests, it has been contemplated that a set of robust (dominative) features may be selected from the candidate features for use in the risk analysis model. Therefore, at step 410, a set of robust (or dominative features) is selected.

For example, the feature selection module 302 may select a set of dominative features from the candidate features for use by the risk analysis model 202. Different embodiments may use different techniques in selecting the set of dominative features. In some embodiments, one or more feature selection algorithms may be used to select the set of dominative features. Different feature selection algorithms use different sets of criteria and methods to rank the strengths of the features. For example, some feature selection algorithms (univariate feature selection algorithms) may determine the strength of a feature based on how indicative that feature alone for detecting fraudulent transaction requests. Univariate feature selection algorithms have their drawbacks. For example, features that may not be strongly indicative when used alone to detect fraudulent transaction requests, but may be strongly indicative when used in tandem with another feature, may rank very low according to these feature selection algorithms.

Some other feature selection algorithms (multivariate feature selection algorithms) may determine the strength of a feature by considering how indicative when the feature is used along with one or more other features in detecting fraudulent transactions. For example, the feature of an IP address of a source device alone may be a strong feature in detecting fraudulent transaction request, and may rank high according to a univariate feature selection algorithm. On the other hand, the feature of a number of failed login attempts alone may not be very indicative of a fraudulent transaction request. However, a combination of the feature of a number of failed login attempts and a feature of a last time that the user account was successfully accessed together (e.g., there are more than 3 failed attempts in the last minute when the user account was successfully accessed by the user just an hour ago) may be very indicative of detecting fraudulent transaction request. As such, the feature of a number of failed login attempts may rank low according to a univariate feature selection algorithm, but may rank high according to a multivariate feature selection algorithm. Thus, different feature selection algorithms may produce different rankings for the candidate features.

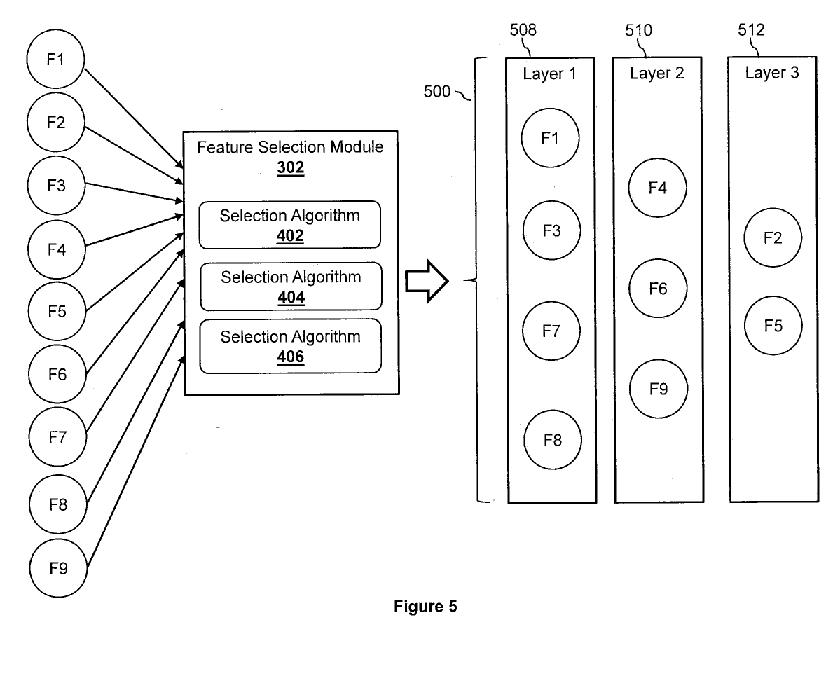

Instead of using one feature selection algorithm, or using multiple feature selection algorithms in series to determine the strengths of the set of robust features, the set of robust features, in one embodiment, is selected by the feature selection module 302 to be dominative over other features across every feature selection algorithm. FIG. 5 illustrates the techniques used by the feature selection module 302 in selecting the set of dominative features according to one embodiment. As shown in FIG. 5, an initial set of nine candidate features (F1-F9) is deter fined to be relevant to detecting fraudulent transaction requests. The feature selection module 302 applies multiple feature selection algorithms, such as selection algorithms 420-406, on the nine features to determine strengths (or scores) of the nine features. In some embodiments, the multiple feature selection algorithms include at least one univariate feature selection algorithm and at least one multivariate feature selection algorithm. As discussed above, each of the feature selection algorithms 402-406 may use different criteria or methods to assess the strengths of the nine features, and as such, the score generated for a feature by each of the different feature selection algorithms 402-406 may be different from each other.

Using the scores generated by the multiple feature selection algorithms 402-406 for the nine features, the feature selection module 302 generates a structure 500 for sorting the nine features. As shown, the structure 500 includes multiple layers of features. In this example, based on the scores generated by the multiple feature selection algorithms 402-406 for the nine features, the structure has three layers—a layer 508 (first layer), a layer 510 (second layer), and a layer 512 (third layer). Each layer may include one or more features. In some embodiments, the structure 500 is arranged such that the features in one layer are dominative over the features in any subsequent layers. For example, the features in the first layer (the layer 508), including the features F1, F3, F7, and F8, are dominative over the features in the second layer (the layer 510) and the features in the third layer (the layer 512). Similarly, the features in the second layer (the layer 510), including the features F4, F6, and F9, are dominative over the features in the third layer (the layer 512). On the other hand, features that are within the same layer are not dominative over one another.

A first feature is dominative over a second feature when each of the multiple feature selection algorithms 402-406 gives a score for the first feature higher than a score for the second feature. Two features are not dominative over one another when one or more feature selection algorithms give a better score to one feature and another one or more feature selection algorithms give a better score to the other feature. Using this technique, the weak features (the features that score low according to the multiple different feature selection algorithms 402-406) may be identified and removed from the selection. The remaining features become the set of robust features. Thus, based on the structure 500, the feature selection module 302 may select features in the top one or more layers (e.g., the features from the first layer 508) to be included in the set of dominative features.

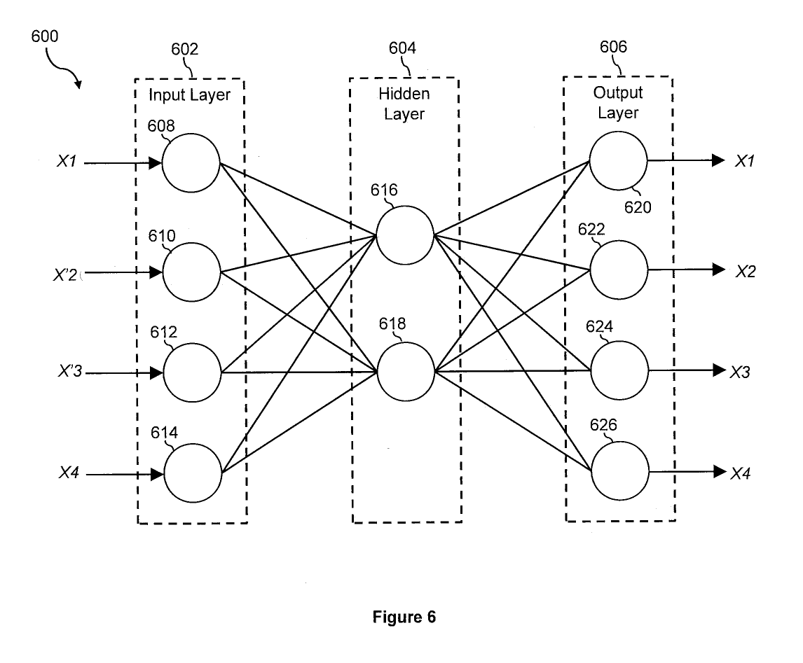

Once the set of dominative (robust) features is selected, the feature selection module 302 passes the set of dominative features to the stacked de-noising auto encoder 304, which takes the set of dominative features, and reduces (or compresses) (at step 415) the set of dominative features into a smaller number of representations for the risk analysis model 202. Each representation may include a mathematical computation based on the set of dominative features. In some embodiments, the mathematical computation of each representation may include applying different weights to each dominative feature in the set of dominative features. In some embodiments, the stacked de-noising auto-encoder 304 reduces the set of dominative features to the smaller number of representations by using an artificial neural network. FIG. 6 illustrates an example artificial neural network 600 generated by the stacked de-noising auto encoder 304. As shown, the artificial neural network 600 includes three layers—an input layer 602, a hidden layer 604, and an output layer 606. Each of the layers 602, 604, and 606 may include one or more nodes. For example, the input layer 602 includes nodes 608-614, the hidden layer 604 includes nodes 616-618, and the output layer 606 includes nodes 620-626. Each node in a layer is connected to every node in an adjacent layer. For example, the node 608 in the input layer 602 is connected to both of the nodes 616-618 in the hidden layer 604. Similarly, the node 616 in the hidden layer is connected to all of the nodes 608-614 in the input layer 602 and all of the nodes 620-626 in the output layer 606. Although only one hidden layer is shown for the artificial neural network 600, it has been contemplated that the artificial neural network 600 generated by the stacked de-noising auto encoder 304 may include more than one hidden layers.

A typical artificial neural network receives a set of input values and produces a set of output values. Each node in the input layer 602 corresponds to a distinct input value, while each node in the output layer 606 corresponds to a distinct output value. In some embodiments, the stacked de-noising encoder 304 generates the artificial neural network 600 to receive data values corresponding to the set of dominative features as input data. For example, since the feature selection module 302 selects features from the first layer 508 (the features F1, F3, F7, and F8) of the structure 500 as the set of dominative features, the artificial neural network 600 includes four nodes 608-614 in the input layer 602 that correspond to the four features F1, F3, F7, and F8.

As discussed above, each of the nodes 616-618 in the hidden layer 604 is connected to all of the nodes 608-614 in the input layer. As such, each of the nodes 616 and 618 receives all four data values from the nodes 608-614 in the input layer 602. In some embodiments, each of the nodes 616-618 in the hidden layer 604 generates a representation, which may include a mathematical computation (or algorithm) that produces a value based on the input values received from the nodes 608-614. The mathematical computation may include assigning different weights to each of the data values received from the nodes 608-614. The nodes 616 and 618 may include different algorithms and/or different weights assigned to the data variables from the nodes 608-614 such that the nodes 616-618 may produce different values based on the same input values received from the nodes 608-614. In some embodiments, the weights that are initially assigned to the features (or input values) for each of the nodes 616-618 may be randomly generated (e.g., using a computer randomizer). The values generated by the nodes 616 and 618 may be used by the nodes 620-626 in the output layer 606 to produce output values for the artificial neural network 600.

As shown, the artificial neural network 600 includes four nodes 620-626 in the output layer 606, which corresponds to four output values. In some embodiments, the four output values correspond to the four dominative features. In other words, the artificial neural network 600 is configured to reproduce the input values based on the values generated by the nodes 616-618 in the hidden layer 604. By providing training data to the artificial neural network 600, the nodes 616-618 in the hidden layer 604 may be trained (adjusted) such that the computed values that the representations (or the algorithms) of the nodes 616-618 in the hidden layer 604 generate may be used by the nodes 620-626 in the output layer 606 to accurately reproduce the input values. By continuously providing different sets of training data, and penalizes the artificial neural network 600 when inaccurate output values are produced, the artificial neural network 600 (and specifically, the representations of the nodes in the hidden layer 604) may be trained (adjusted) to improve its performance in reproducing the input values over time. Adjusting the artificial neural network 600 may include adjusting the weights assigned to the different dominative features in the representation of each node in the hidden layer 604. The weights may be continually adjusted with new training data until the artificial neural network 600 can accurately reproduce the input values at a rate beyond a predetermined threshold.

It has been contemplated that the characteristics of fraudulent transaction requests in the future may vary from that of the training data, for example, due to changes in fraud trends and the user population as discussed above. To anticipate these variations, during training of the artificial neural network, the stacked de-noising auto-encoder 304 may introduce noise to the network 600 by corrupting some of the input data and providing the corrupted input data to the artificial neural network 600. For example, as shown in FIG. 6, when a set of training data X1, X2, X3, and X4, that corresponds to the respective features F1, F3, F7, and F8 are obtained, the stacked de-noising auto-encoder 304 may corrupt the data X2 and X3 to generate corrupted data X′2 and X′3. As a result, the input data X1, X′2, X′3, and X4 are provided as input data to the artificial neural network 600 as shown in FIG. 6. Since the stacked de-noising auto-encoder 304 still expects the artificial neural network 600 to output the original input data X1, X2, X3, and X4, given sufficient training data, the artificial neural network 600 may be trained (adjusted) to reproduce the original input data even though some of the input data is corrupted.

After going through the training, the nodes in the hidden layer 604 are adjusted in a manner that they can reproduce the original input values. In other words, the nodes 616 and 618 and the values they generate, while fewer in number, can accurately represent all of the input variables. As such, in step 420, the process 400 may generate the risk analysis model based on the artificial neural network. For example, the stacked de-noising auto-encoder 304 may generate the risk analysis model 202 by using the nodes in the hidden layer 604 as the input nodes of the risk analysis model 202. In some embodiments, the risk analysis model 202 may be a standard stacked, fully-connected, feed-forward neural network, having the nodes from the hidden layer 604 as the input nodes.

Using the nodes in the hidden layer 604 as the input nodes in the risk analysis model 202 improves the computation efficiency as less variables is used to perform the computation within the hidden layer of the risk analysis model 202, while maintaining the accuracy since the nodes in the hidden layer 604 can accurately represent the input variables based on the training performed on the artificial neural network 600. Furthermore, using a smaller number of input nodes reduces the dimensionality of the final risk analysis model 202 and/or reduces the redundancy or correlation that might exist between the original set of dominative features. The risk analysis model 202 may then be used by the risk analysis module 132 to detect fraudulent transaction requests.

The techniques described above may be used to generate a robust risk analysis computer model for predicting fraudulent transaction requests. In some embodiments, the training data that is used to train the computer model may come from data across a long period of time (e.g., 5 years, 10 years, etc.) and across multiple fraud sub-domains (e.g., the account take over frauds sub-domain, the card frauds sub-domain, etc.) to ensure that the risk analysis model can capture a variety of types of fraudulent transaction requests. This “generic” training data that is not time-frame specific and not fraud domain specific may cause the generated risk analysis model to be a robust generic risk analysis model. However, one may desire to have a risk analysis model that targets a specific time frame (e.g., targeting the latest fraud trend, etc.) or targets a specific fraud domain (e.g., the account take over frauds domain, the card frauds domain, etc.).

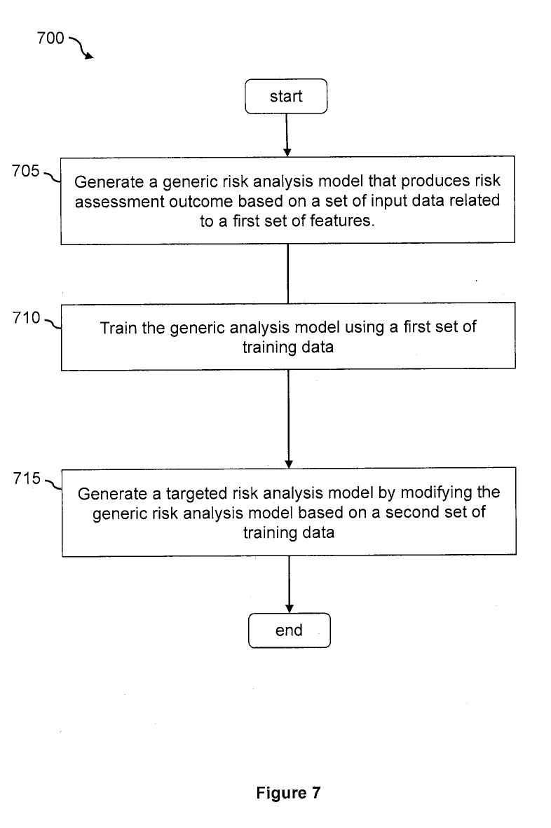

One can use the techniques described above to build different risk analysis models for different time frames, and to build different risk analysis models for different fraud domains. However, constantly building new risk analysis models for targeting different time frames and/or different fraud domains, as new fraud trends evolve or old fraud trends reemerge, can be costly. As such, in another aspect of the disclosure, systems and methods for enhancing a generic risk analysis model to produce a targeted risk analysis model using a knowledge transfer technique is presented. FIG. 7 illustrates a process 700 for building targeted risk analysis model based on the knowledge transfer technique.

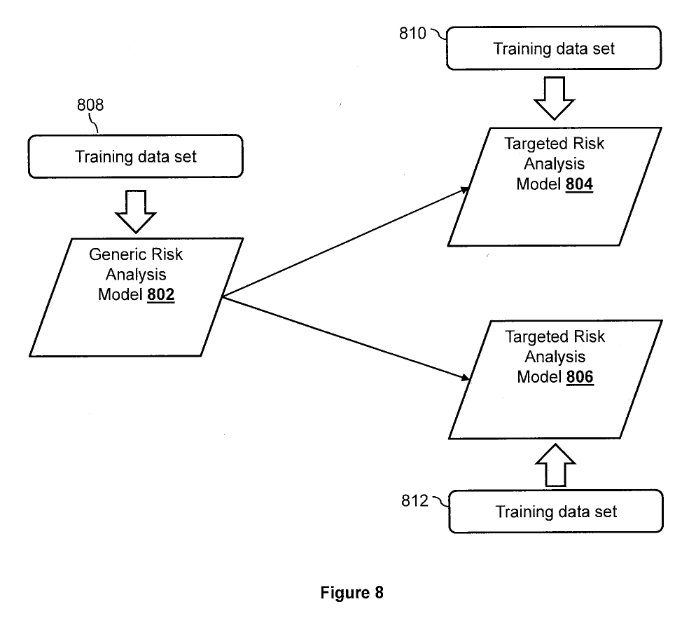

The process 700 begins with generating (at step 705) a generic risk analysis model that produces risk assessment outcome based on a set of input data related to a first set of features. In some embodiments, the model generation module 204 may use the techniques described above to generate a generic risk analysis model. Referring to FIG. 8, in some embodiments, the module generation module 204 may use the feature selection module 302 and the stacked de-noising auto-encoder 304 to generate the initial generic risk analysis model 802 as discussed above. The process 700 then trains (at step 710) the generic analysis model using a first set of training data. For example, the model generation module 204 may select training data having first characteristics as the first set of training data. The first characteristics may include temporal-independent and domain-independent. For example, the first set of training data may be obtained over a long period of time (e.g., 5 years, 10 years, etc.) such that the training data covers fraud trends across different time periods. Furthermore, the first set of training data may be indiscriminative with respect to the types of fraud being utilized in the fraudulent transactions, such that it covers the entire fraud domain. Selecting the first set of training data having the first characteristics to train the generic risk analysis model 802 causes the generic risk analysis model 802 to have improved performance in detecting fraudulent transaction requests in general. As a result, the generic risk analysis model 802 may detect fraudulent transaction requests that utilize fraud tactics that have been trendy or in relatively high use in recent times as well as fraud tactics that have not been used in recent times but slowly reemerging. Furthermore, the generic risk analysis model 802 may also detect fraudulent transaction requests under a variety of fraud sub-domains such as the account take over sub-domain and the card fraud sub-domain.

While the generic risk analysis model 802 provides good performance in terms of detecting fraudulent transaction requests in general (e.g., correctly identifying a certain percentage of transaction requests), it may still be enhanced to provide improved performance for detecting targeted types of fraudulent transaction requests (e.g., correctly identifying a percentage higher than the certain percentage). For example, due to a recent trend of fraud characteristics, while the generic risk analysis model 802 may detect fraudulent transaction requests in general at a rate of 90%, one may desire to have a targeted risk analysis model that may detect fraudulent transaction requests having the recent trend of fraud characteristics at a higher rate (e.g., at 95%, 98%, etc.). In some embodiments, instead of building a new risk analysis model that targets the recent trend of fraud characteristics from the beginning, the process 700 generates (at step 715) a targeted risk analysis model by modifying the generic risk analysis model based on a second set of training data.

In some embodiments, the model retraining module 306 of the model generation module 204 may first determine a type of knowledge transfer that is being requested. For example, the model retraining module 306 may provide a user interface (e.g., a webpage via the web server 134) that enables a user of the model generation module 204 to provide a knowledge transfer request. The knowledge transfer request may indicate a type of knowledge transfer request, such as a temporal-based knowledge transfer or a domain-based knowledge transfer. When a temporal-based knowledge transfer is selected, the user may provide a specific period of time that the targeted risk analysis model should target or analyze (e.g., the last three months, the last year, etc.). The model retraining module 306 may then select training data corresponding to the specified time period as the second set of training data. The second set of training data may have second characteristics. In this example, the second characteristics may be temporal-based and correspond to the specified time period. As such, the second set of training data may correspond to a time period that is subsequent of the first set of training data. In some embodiments, the second set of training data may correspond to a time period that is shorter than the time period of the first set of training data.

When a domain-based knowledge transfer is selected, the user may provide a specific fraud sub-domain (e.g., the account take over fraud sub-domain or the card fraud sub-domain, etc.) that the targeted risk analysis model should target. The model retraining module 306 may then select training data corresponding to the specified fraud sub-domain as the second set of training data. The second set of training data may have second characteristics. In this example, the second characteristics may be domain-based and correspond to the specified fraud sub-domain.

According to various embodiments of the disclosure, the model generation module 204 may also automatically initiate a knowledge transfer to generate one or more new targeted risk analysis models. For example, the model generation module 204 may track a performance (e.g., a fraudulent request detection rate) of a risk analysis model that is being currently used by the service provider server 130. The risk analysis model that is being currently used may be a generic risk analysis model (e.g., the generic risk analysis model 802) or a targeted risk analysis model that was previously generated. When the performance of the current risk analysis model falls below a threshold previously defined by a user of the model generation module 204 (e.g., below 70% detection rate), the model generation module 204 may automatically initiate a knowledge transfer request to generate a new targeted risk analysis model. In some embodiments, when it is determined that the current risk analysis model is a generic risk analysis model or a targeted risk analysis model based on obsolete training data (e.g., the training data that is obtained more than a predetermined time (e.g., a year) ago, etc.) the model retraining module 306 may select training data that corresponds to a more recent time period (e.g., last two months, last year, etc.) as the second set of training data. In this example, the second characteristics of the second set of training data may be domain-based and correspond to the time period selected by the model retraining module 306.

In some embodiments, prior to re-training the generic risk analysis model 802 with the second set of training data, the model retraining module 306 may use the feature selection module 302 to select additional features that are dominative in detecting fraudulent transaction requests based on the second set of training data. For example, one or more features that may not be determined as dominative based on the first set of training data may be dominative based on the second set of training data. As such, the model retraining module 306 may modify the generic risk analysis model 802 by adding the additional dominative features to the first set of features as input to generate a new targeted risk analysis model, such as a targeted risk analysis model 804. The model retraining module 306 then trains the targeted risk analysis model 804 using the second set of training data (e.g., the training data set 810). Training the targeted risk analysis model 804 may cause at least some of the weights assigned to different input features to be adjusted. After training the targeted risk analysis model 804, the targeted risk analysis model 804 may be used by the risk analysis module 132 for detecting fraudulent transaction requests for the service provider server 130.

Targeted risk analysis models that are generated using the knowledge transfer techniques described above offer many benefits. For example, by using the knowledge transfer techniques to generate new targeted risk analysis models, knowledge that has been acquired by the generic risk analysis model (e.g., the generic risk analysis model 802) may be transferred to the new targeted risk analysis model (e.g., the targeted risk analysis model 804). As such, the targeted risk analysis model 804 not only may have higher performance for detecting fraudulent transaction requests in the targeted areas (e.g., the targeted time period, the targeted fraud sub-domain, etc.), the targeted risk analysis model 804 may also retain its ability to detect fraudulent transaction requests generally and in other non-targeted areas as well. By contrast, a targeted risk analysis model that is generated from scratch (and/or based purely on the second set of training data) may suffer in performance when the fraud trend changes or when a transaction request is misclassified (e.g., the request should be analyzed under a risk analysis model that targets account take over frauds, but is sent to be analyzed using a risk analysis model that targets card frauds).

According to various embodiments of the disclosure, the model retraining module 306 may use the same generic risk analysis model (e.g., the generic risk analysis model 802) to generate multiple targeted risk analysis models targeting different time periods or different fraud sub-domains. For example, after generating the targeted risk analysis model 804 using the training data set 810, the model retraining module 306 may select a third set of training data (e.g., a training data set 812) to generate another targeted risk analysis model (e.g., a targeted risk analysis model 806). The third set of training data 812 may have third characteristics different than the first characteristics and the second characteristics. For example, the second set of training data may correspond to a first fraud sub-domain (e.g., the account take over fraud sub-domain) while the third set of training data may correspond to a second fraud sub-domain (e.g., the card fraud sub-domain). In another example, the second set of training data may correspond to a specified time period while the third set of training data may correspond to a specified fraud sub-domain. As such, multiple targeted risk analysis models may be provided to the risk analysis module 132 for use concurrently for detecting fraudulent transaction requests.

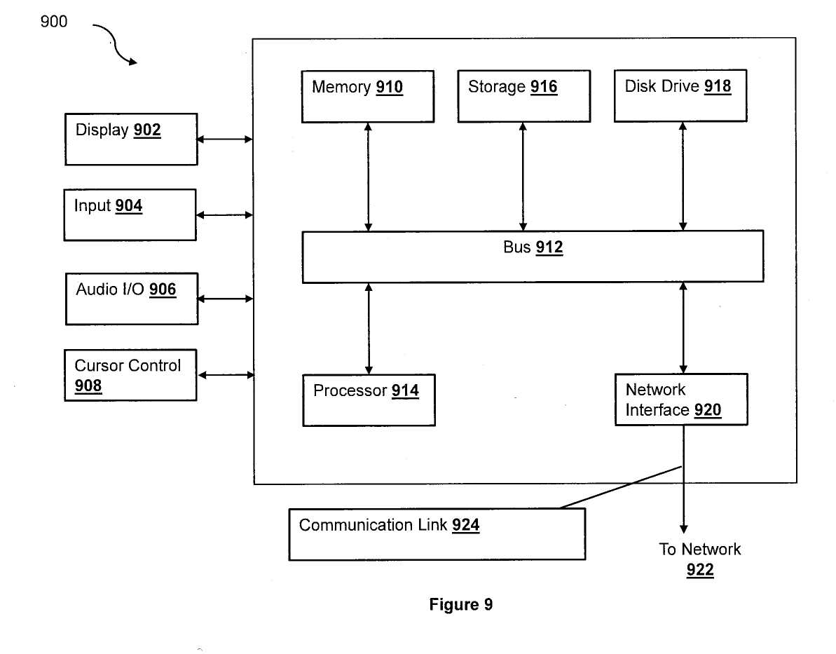

FIG. 9 is a block diagram of a computer system 900 suitable for implementing one or more embodiments of the present disclosure, including the service provider server 130, the merchant server 120, and the user device 110. In various implementations, the user device 110 may include a mobile cellular phone, personal computer (PC), laptop, wearable computing device, etc. adapted for wireless communication, and each of the service provider server 130 and the merchant server 120 may include a network computing device, such as a server. Thus, it should be appreciated that the devices 110, 120, and 130 may be implemented as the computer system 900 in a manner as follows.

The computer system 900 includes a bus 912 or other communication mechanism for communicating information data, signals, and information between various components of the computer system 900. The components include an input/output (I/O) component 904 that processes a user (i.e., sender, recipient, service provider) action, such as selecting keys from a keypad/keyboard, selecting one or more buttons or links, etc., and sends a corresponding signal to the bus 912. The I/O component 904 may also include an output component, such as a display 902 and a cursor control 908 (such as a keyboard, keypad, mouse, etc.). The display 902 may be configured to present a login page for logging into a user account or a checkout page for purchasing an item from a merchant. An optional audio input/output component 906 may also be included to allow a user to use voice for inputting information by converting audio signals. The audio I/O component 906 may allow the user to hear audio. A transceiver or network interface 920 transmits and receives signals between the computer system 900 and other devices, such as another user device, a merchant server, or a service provider server via network 922. In one embodiment, the transmission is wireless, although other transmission mediums and methods may also be suitable. A processor 914, which can be a micro-controller, digital signal processor (DSP), or other processing component, processes these various signals, such as for display on the computer system 900 or transmission to other devices via a communication link 924. The processor 914 may also control transmission of information, such as cookies or IP addresses, to other devices.

The components of the computer system 900 also include a system memory component 910 (e.g., RAM), a static storage component 916 (e.g., ROM), and/or a disk drive 918 (e.g., a solid state drive, a hard drive). The computer system 900 performs specific operations by the processor 914 and other components by executing one or more sequences of instructions contained in the system memory component 910. For example, the processor 914 can perform the risk analysis model generation functionalities described herein according to the processes 400, and 700.

Logic may be encoded in a computer readable medium, which may refer to any medium that participates in providing instructions to the processor 914 for execution. Such a medium may take many forms, including but not limited to, non-volatile media, volatile media, and transmission media. In various implementations, non-volatile media includes optical or magnetic disks, volatile media includes dynamic memory, such as the system memory component 910, and transmission media includes coaxial cables, copper wire, and fiber optics, including wires that comprise the bus 912. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 900. In various other embodiments of the present disclosure, a plurality of computer systems 900 coupled by the communication link 924 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A method of building a computer model, the method comprising:
obtaining, by one or more hardware processors, a plurality of candidate features that are associated with the computer model;
using, by the one or more hardware processors, a plurality of different feature selection algorithms to select a subset of features from the plurality of candidate features that are determined to be dominative relative to fraud detection over the remaining candidate features in the plurality of candidate features according to the plurality of different feature selection algorithms;
generating, by the one or more hardware processors, a number of representations to represent the subset of features, wherein the number of representations is less than the subset of features; and
building, by the one or more hardware processors, the computer model based on the generated representations.

2. The method of claim 1, wherein using the plurality of different feature selection algorithms to select the subset of features comprises:
sorting the plurality of candidate features into a plurality of layers of candidate features based on the plurality of different feature selection algorithms, wherein each candidate feature in a first layer is determined to be dominative relative to fraud detection over candidate features in the remaining layers according to the plurality of different feature selection algorithms; and
selecting one or more candidate features from the first layer as the subset of features.

3. The method of claim 2, wherein each candidate feature in the first layer is not determined to be dominative relative to fraud detection over other candidate features in the first layer according to the plurality of different feature selection algorithms.

4. The method of claim 1, wherein each representation in the number of representations comprises a mathematical computation based on the selected subset of features.

5. The method of claim 4, wherein the mathematical computation of each representation comprises applying a weight to each feature in the selected subset of features.

6. The method of claim 1, wherein generating the number of representations comprises using the selected subset of features as input features to a computer-based neural network.

7. The method of claim 6, wherein the computer-based neural network comprises a plurality of hidden layers.

8. The method of claim 1, wherein the computer model predicts whether a transaction is a fraudulent transaction.

9. The method of claim 8, wherein the plurality of candidate features comprises at least one of: an Internet Protocol (IP) address, a number of successful transactions within a predetermined period of time, a number of failed transactions within the predetermined period of time, a time, a browser type, a device type, an amount associated with the transaction, or a transaction type of the transaction.

10. The method of claim 1, wherein the plurality of different feature selection algorithms comprises at least one univariate feature selection algorithm and at least one multivariate feature selection algorithm.

11. A system comprising:
a non-transitory memory; and
one or more hardware processors coupled to the non-transitory memory and configured to read instructions from the non-transitory memory to cause the system to perform operations comprising:
obtaining a plurality of candidate features that are relevant to the computer model;
using a plurality of different feature selection algorithms to select a subset of features from the plurality of candidate features that are determined to be dominative over the remaining candidate features relative to fraud detection in the plurality of candidate features according to the plurality of different feature selection algorithms;
generating a number of representations to represent the subset of features, wherein the number of representations is less than the subset of features; and
building the computer model based on the generated representations.

12. The system of claim 11, wherein using the plurality of different feature selection algorithms to select the subset of features comprises:
sorting the plurality of candidate features into a plurality of layers of candidate features based on the plurality of different feature selection algorithms, wherein each candidate feature in a first layer is determined to be dominative over candidate features in the remaining layers according to the plurality of different feature selection algorithms; and
selecting one or more candidate features from the first layer as the subset of features.

13. The system of claim 12, wherein each candidate feature in the first layer is not dominative over other candidate features in the first layer according to the plurality of different feature selection algorithms.

14. The system of claim 11, wherein each representation in the number of representations comprises a mathematical computation based on the selected subset of features.

15. The system of claim 14, wherein the mathematical computation of each representation comprises applying a weight to each feature in the selected subset of features.

16. The system of claim 11, wherein the operations further comprise generating a computer-based neural network using the selected subset of features as input features.

17. The system of claim 16, wherein the generated computer-based neural network comprises a plurality of hidden layers.

18. The system of claim 11, wherein the computer model predicts whether a transaction is a fraudulent transaction.

19. A non-transitory machine readable medium having stored thereon machine-readable instructions executable to cause a machine to perform operations comprising:
obtaining a plurality of candidate features that are relevant to the computer model;
using a plurality of different feature selection algorithms to select a subset of features from the plurality of candidate features that are dominative over the remaining candidate features in the plurality of candidate features according to the plurality of different feature selection algorithms;
generating a number of representations to represent the subset of features, wherein the number of representations is less than the subset of features; and
building the computer model based on the generated representations.

20. The non-transitory machine readable medium of claim 19, wherein the plurality of different feature selection algorithms comprises at least one univariate feature selection algorithm and at least one multivariate feature selection algorithm.
